(19) United States
(12) Patent Application Publication
(10) Pub. No.: US 2020/0050973 A1
(43) Pub. Date: Feb. 13, 2020

(54) METHOD AND SYSTEM FOR SUPERVISED LEARNING OF ROAD SIGNS

(71) Applicant: HERE GLOBAL B.V., Eindhoven (NL)

(72) Inventor: Leon STENNETH, Chicago, IL (US)

(21) Appl. No.: 16/102,351

(22) Filed: Aug. 13, 2018

(51) Int. Cl. G06N 99/00; G01C 21/32; G06N 5/04

(52) U.S. Cl. CPC G06N 99/005; G06N 5/04; G01C 21/32

(57) ABSTRACT

A method, system, and computer program product is provided, for example, for predicting a location of a road sign. In an example embodiment, the method may include receiving a set of pre-processed road observations and extracting a plurality of features from the set of pre-processed road observations, wherein the plurality of features comprise at least a plurality of sensor based features and a plurality of map based features. Further, the method may include associating a set of sensor based features from the plurality of sensor based features and a set of map based features from the plurality of map based features with at least one of a plurality of ground truth points in ground truth data. Additionally, the method may include training a machine learning model based on the association of the ground truth data with the set of sensor based features and the set of map based features with at least one of a plurality of ground truth points in the ground truth data and further predicting the location of the road sign based on the trained machine learning model.

### TECHNOLOGICAL FIELD

The present disclosure generally relates to a system and method for providing assistance to a driver of a vehicle or the vehicle itself, and more particularly relates to a system and method for supervised learning of road signs.

### BACKGROUND

The automotive industry is witnessing a rapid shift towards advanced driving automation solutions. The purpose of driving automation is to provide safe, comfortable and efficient mobility solutions for users and drivers alike. The real efficiency of an automated driving solution lies in how much of driving burden can it reduce, while providing efficient, accurate and risk-free driving decisions. Many automated driving solutions are based on usage of map databases for providing environmental, regulatory, and navigation related information in near real-time for performing driving actions in fully or semi-automated vehicles. Such map databases are updated with data related to road signs, speed limits, traffic conditions and the like, either using real-time crowd sourced data or by receiving regular updates to data.

Currently, collection of data for map databases may involve using probe vehicles to drive around numerous streets in the world to detect road objects such as road signs, gantries, static road objects, destination signs, traffic signs, traffic conditions, diversions, blockages and the like. This process can be highly time consuming, resource intensive and expensive. In some scenarios, this may not be a practical approach for data collection for map databases.

Sometimes, navigation applications in vehicles may use complementary information along with data stored in map databases for deriving information for taking driving decisions with greater accuracy and precision. Such complementary information may include data received from the vehicles' on-board sensors such as cameras, motion sensors, laser light radar (LiDAR) sensors, GPS sensors and the like. The data derived from map database, complemented with sensor based data, and including driver cognition may be used to enhance the accuracy of driving assistance decisions implemented in the vehicle. The data derived in this manner should be highly accurate, reliable, precise and up-to-date in order to provide advanced driving assistance in the vehicle, such as a semi-autonomous or a fully autonomous vehicle.

### BRIEF SUMMARY

In light of the above-discussed problems, there is a need to derive accurate data related to road objects in general and road signs in particular, using information derived from both a map based source, such as a cloud based map database, and a sensor based source, such as sensors installed in a vehicle. The road objects may include road signs such as static speed signs or variable speed signs (VSS), gantries, destination boards, banners, obstructions on a road, boulders, advertisement banners, display objects and the like. The road objects may be detected using probe vehicles, which may be cars equipped with various sensors such as motion sensors, 360-degree cameras, laser light radar (LiDAR) sensors and the like. This data may also be combined with satellite and aerial imagery to turn the vast amounts of data into highly accurate maps configured for advanced navigation applications. The collection of such vast amounts of data may incur huge vehicle miles, making the whole process highly time consuming and expensive.

The methods and systems disclosed herein address this problem by providing solutions for automated learning of data related to road objects in general and road signs in particular using a supervised learning methodology for learning about road signs. Thus, the methods and systems discussed herein may provide huge savings in time, cost and resources by collecting data about few ground truth points, and using additional data from sensor based features and map based features, and then train a machine learning model to automatically recognize road objects, such as road signs. The machine learning model may utilize the ground truth and learn the map and sensor based patterns of road signs from map based features and sensor based features and then predict the location of the road signs from the map data and the sensor data. Thus, the probe vehicles may not be required to drive all the streets in the world for data collection and road sign detection.

It is to be understood by those of ordinary skill in the art that the methods and systems disclosed herein may be discussed with reference to road signs for exemplary purpose only, and the discussion of road signs is by no means intended to limit the scope of the invention. The invention may also reasonably be applied for other road objects without deviating from the scope of the invention.

In an example embodiment, a method for predicting a location of a road sign is provided. The method may include receiving a set of pre-processed road observations. The method may further include extracting a plurality of features from the set of pre-processed road observations, wherein the plurality of features comprise at least a plurality of sensor based features and a plurality of map based features. Further, the method may include associating a set of sensor based features from the plurality of sensor based features and a set of map based features from the plurality of map based features with at least one of a plurality of ground truth points in ground truth data. Additionally, the method may include training a machine learning model based on the association of the ground truth data with the set of sensor based features and the set of map based features with at least one of a plurality of ground truth points in the ground truth data. Further, the method may include predicting the location of the road sign based on the trained machine learning model.

In some example embodiment, an apparatus for predicting a location of a road sign may be provided. The apparatus may include at least one processor and at least one memory including computer program code for one or more programs. Further, the at least one memory and the computer program code may be configured to with the at least one processor cause the apparatus to perform to at least receive a set of pre-processed road observations. The apparatus may be further caused to extract a plurality of features from the set of pre-processed road observations, wherein the plurality of features comprise at least a plurality of sensor based features and a plurality of map based features. Additionally, the apparatus may be caused to associate a set of sensor based features from the plurality of sensor based features and a set of map based features from the plurality of map based features with at least one of a plurality of ground truth points in ground truth data. Also, the apparatus may be caused to train a machine learning model based on the association of the ground truth data with the set of sensor based features and the set of map based features with at least one of a plurality of ground truth points in the ground truth data. Additionally, the apparatus may be caused to predict the location of the road sign based on the trained machine learning model.

In some example embodiments a computer program product is provided. The computer program product comprising at least one non-transitory computer-readable storage medium having computer-executable program code instructions stored therein, the computer-executable program code instructions comprising program code instructions for receiving a set of pre-processed road observations. The computer-executable program code instructions further comprising program code instructions for extracting a plurality of features from the set of pre-processed road observations, wherein the plurality of features comprise at least a plurality of sensor based features and a plurality of map based features. The computer-executable program code instructions further comprising program code instructions for associating a set of sensor based features from the plurality of sensor based features and a set of map based features from the plurality of map based features with at least one of a plurality of ground truth points in ground truth data. Additionally, the computer-executable program code instructions comprising program code instructions for training a machine learning model based on the association of the ground truth data with the set of sensor based features and the set of map based features with at least one of a plurality of ground truth points in the ground truth data. Also, the computer-executable program code instructions comprising program code instructions for predicting the location of the road sign based on the trained machine learning model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a system for predicting a location of a road sign in accordance with an example embodiment;

FIG. 2 illustrates a diagram showing a plurality of types of road signs in accordance with an example embodiment;

FIG. 3 illustrates an exemplary diagram illustrating segmentation of a link for predicting location of a road sign according to an example embodiment;

FIG. 4 illustrates an exemplary diagram illustrating association of a plurality of map based features and a plurality of sensor based features with ground truth data according to an example embodiment;

FIG. 5 illustrates a flow diagram of a method for predicting a location of a road sign according to an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference, numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

### Definitions

The term “link” may be used to refer to any connecting pathway including but not limited to a roadway, a highway, a freeway, an expressway, a lane, a street path, a road, an alley, a controlled access roadway, a free access roadway and the like.

The term “shape point” may be used to refer to shape segments representing curvature information of various links, such as roadway segments, highway segments, roads, expressways and the like. Each shape point may be associated with coordinate information, such as latitude and longitude information. The intersections of shape points may be represented as nodes.

The term “node” may be used to refer to a point, such as a point of intersection between two line segments, which in some cases may be link segments.

The term “upstream link” may be used to refer to a link in a running direction or direction of travel of a vehicle.

The term “downstream link” may be used to refer to a link opposite to a running direction or direction of travel of a vehicle.

The term “heading” may be used to provide a measure of a direction for a point or a line and may be calculated relative to a north direction or a line-of-sight direction, as may be applicable.

The term “road sign” may be used to refer to any traffic or non-traffic related road sign, such as a static speed limit sign, a variable speed sign (VS S), a destination sign board, a direction indicator sign board, a banner, a flyer, a gantry, a hoarding, an advertisement and the like.

A method, apparatus, and computer program product are provided herein in accordance with an example embodiment for predicting a location of a road sign using sensor based data from a vehicle and map based data from a map application platform, which may be a cloud based map application platform. In some example embodiments, the methods and systems provided herein may also be used for detecting and predicting location of other road objects apart from road signs. Such road objects may include static objects on road, road blockages, diversion signs, accident spots, infrastructural components, lane dividers and the like. In some example embodiments, the methods and systems disclosed herein may provide automated location recognition for road objects and road signs using a supervised learning algorithm which provides for identification of location of the road sign using a machine learning model.

In some example embodiments, the road sign may be a static speed sign or a variable speed sign. The static speed sign is used to display speed values that are static in nature, which is the speed values that are constant over a link irrespective of any external or environmental conditions or temporal conditions. The variable speed sign on the other hand may be used to display speed values that are variable. In some example embodiments, the road sign, such as the speed limit sign, may be associated with a “permanency flag” that may be set to “static” or “variable” for the static speed sign and the variable speed sign respectively. The “permanency flag” may be stored in a database along with data related to speed signs. The variable speed sign may be displayed on a gantry, such as gantries visible on highways, roadways and other such links. Gantries may display variable speed signs which display multiple speed values based on various environmental conditions such as on time of day, traffic conditions, and the like. The locations of these variable speed signs should be learned and updated timely in a database to provide a good speed reference for autonomous or semi-autonomous vehicles. For another example, for gantry learning, data for multiple days (weekday and weekend) may be learned to increase the chances of detecting varying sign values reported at the same location which would indicate a variable speed sign. The methods and systems disclosed herein provide for such learning and identification of road signs, such as variable speed signs and gantries, based on supervised learning of road signs using map based data and sensor based data, while providing cost saving and accuracy enhancement in detection of road signs while navigating using a vehicle.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

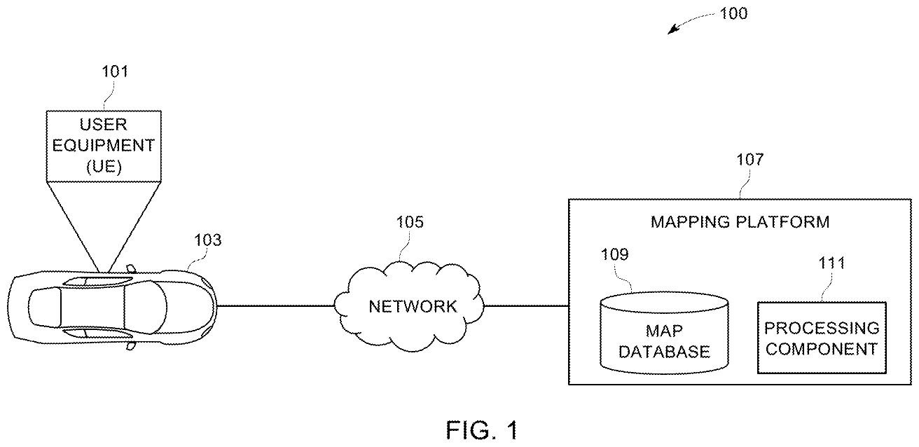

FIG. 1 illustrates a block diagram of a system 100 for predicting a location of a road sign in accordance with an example embodiment. The system 100 may include a user equipment 101 installed in a vehicle 103 for predicting the location of the road sign. The vehicle 103 may include one or more sensors for taking road observations. The road observations may be related to one or more road objects such as road signs, including a traffic sign, a gantry, a poster, a banner, an advertisement flyer, an LCD display, a direction signboard, a destination signboard, a speed limit sign, a variable speed limit sign (VSS) and the like. Thus, the road sign may either be traffic information related sign or a non-traffic information related sign. In some instances, the vehicle 103 may take the road observation in such a manner that a non-traffic information related sign, such as a picture, may be misclassified as traffic information related sign, leading to errors. In some example embodiments, these errors may be due to one or more sensors installed in the vehicle, such as the GPS sensor errors or the camera sensor errors.

In some example embodiments, GPS errors may lead to inaccurate identification of road sign locations and incorrectly map-matching road signs to wrong links. For example, map-matching road signs onto curved links are usually inaccurate if the road observation is simply based on GPS sensor information, such as GPS co-ordinates. In other examples, a static speed sign may be misclassified as a variable speed sign. In yet other examples, gantries containing variable speed signs may be incorrectly reported due to errors in the raw OEM sensor data.

The system 100 may be configured to reduce such OEM sensor related errors to counter this problem and at the same time improving the cost and performance aspects of the navigation related functions performed by the user equipment 101 installed in the vehicle 103.

In some example embodiments, the vehicle 103 may detect a road sign using a sensor, such as a camera installed on the vehicle. The sensor e.g. camera may then send data related to the road sign, also referred to as the road sign observation for further processing, to a cloud based system, such as to a mapping platform 107. The data may then be processed, such as using a processing component 111 of the mapping platform 107 to learn about the road sign, such as a gantry, in a much more precise manner and provide less false positive results to improve the overall tradeoff of quality and coverage.

In some example embodiments, the vehicle 103 may be a probe vehicle that may be used specifically for collecting data related to road signs. The data may be such as ground truth data, which may include information about presence or absence of a road sign or a gantry at various locations on a link. For example, the vehicle 103 may collect ground data at various ground truth points, which may be a plurality of locations, and identify whether the road sign is present at each of those plurality of locations by setting the status of an indicator parameter as “TRUE” if the road sign is present at that ground truth point, and setting the status of the indicator parameter as “FALSE” if the road sign is not present at that ground truth point. The vehicle 103 may be equipped with a plurality of sensors to collect the ground truth data. Such sensors may include advanced sensors such as advanced 360 degree cameras, LiDAR sensors, motion sensors and the like. The probe vehicles may be configured to collect data about the plurality of ground truth points using any of the plurality of sensors provided in the probe vehicle. For example, a probe vehicle's front camera may be used to capture an image of an upcoming gantry and send the image for further analysis and processing to the mapping platform 107. In the mapping platform 107, the image may be stored in a map database 109, along with the status indicator discussed earlier, and retrieved for analysis later for a mapping application. One such mapping application may include a computer vision related application, which may use the image for analyzing the various features of the road sign, such as type of sign, position of the sign, reading or data value posted on the road sign and the like.

In some example embodiments, the images captured and stored in this manner may be related to other road objects as well, such as road curves, speed breakers, lane markings, a turn on a road and the like. The images may be used in computer vision applications to provide various attributes related to the road objects, such as information about one or more road attributes like slope of the road, curvature of the road, a turning radius of the road, height or elevation of the road and similar data. The data may be stored in the map database 109 of the mapping platform and used by various mapping applications.

In an example embodiment, the mapping platform 107 may be used to implement a supervised learning strategy to predict a location of the road sign, based on the ground truth data collected for plurality of ground truth points using the vehicle 103.

In some example embodiments, the mapping platform 107 may be used to implement the supervised learning strategy to predict a location of other road objects apart from road signs.

The vehicle's 103 user equipment 101 may be connected to the mapping platform 107 over a network 105. The mapping platform 107 may include a map database 109 and the processing component 111.

The network 105 may be wired, wireless, or any combination of wired and wireless communication networks, such as cellular, Wi-Fi, internet, local area networks, or the like.

The user equipment 101 may be a navigation system, such as an advanced driver assistance system (ADAS), that may be configured to provide route guidance and navigation related functions to the user of the vehicle 103.

In some example embodiments, the user equipment 101 may include a mobile computing device such as a laptop computer, tablet computer, mobile phone, smart phone, navigation unit, personal data assistant, watch, camera, or the like. Additionally or alternatively, the user equipment 101 may be a fixed computing device, such as a personal computer, computer workstation, kiosk, office terminal computer or system, or the like. The user equipment 101 may be configured to access the mapping platform 107 via a processing component 111 through, for example, a mapping application, such that the user equipment 101 may provide navigational assistance to a user, provide predictive traffic alerts to the user, help in fleet management, predicting upcoming road horizon, providing parking assistance, help in route planning and the like.

The mapping platform 107 may include a map database 109, which may include node data, road segment data, link data, point of interest (POI) data, link identification information, heading value records or the like. The map database 109 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 109 may contain path segment and node data records, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 109 can include data about the POIs and their respective locations in the POI records. The map database 109 may additionally include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 109 can include event data (e.g., traffic incidents, construction activities, scheduled events, unscheduled events, accidents, diversions etc.) associated with the POI data records or other records of the map database 109 associated with the mapping platform 107.

A content provider e.g., a map developer may maintain the mapping platform 107. By way of example, the map developer can collect geographic data to generate and enhance mapping platform 107. There can be different ways used by the map developer to collect data. These ways can include obtaining data from other sources, such as municipalities or respective geographic authorities, using satellite imagery, crowdsourcing and the like. In addition, the map developer can employ field personnel to travel by vehicle along roads throughout the geographic region to observe features and/or record information about them, for example. Crowdsourcing of geographic map data can also be employed to generate, substantiate, or update map data. For example, sensor data from a plurality of data probes, which may be, for example, vehicles traveling along a road network or within a venue, may be gathered and fused to infer an accurate map of an environment in which the data probes are moving. The sensor data may be from any sensor that can inform a map database of features within an environment that are appropriate for mapping. For example, motion sensors, inertia sensors, image capture sensors, proximity sensors, LIDAR (light detection and ranging) sensors, ultrasonic sensors etc. The gathering of large quantities of crowd-sourced data may facilitate the accurate modeling and mapping of an environment, whether it is a road segment or the interior of a multi-level parking structure. Also, remote sensing, such as aerial or satellite photography, can be used to generate map geometries directly or through machine learning as described herein.

In some example embodiments, the sensor data may be gathered in real-time or by using batch processing depending upon the type of OEM sensor installed in the vehicle 103.

The map database 109 of the mapping platform 107 may be a master map database stored in a format that facilitates updating, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, driving maneuver related functions and other functions, by a navigation device, such as by user equipment 101, for example. The navigation device may be used to perform navigation-related functions that can correspond to vehicle navigation, pedestrian navigation, and vehicle lane changing maneuvers, vehicle navigation towards one or more geo-fences, navigation to a favored parking spot or other types of navigation. While example embodiments described herein generally relate to vehicular travel and parking along roads, example embodiments may be implemented for bicycle travel along bike paths and bike rack/parking availability, boat travel along maritime navigational routes including dock or boat slip availability, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

In some embodiments, the map database 109 may be a master geographic database configured at a server side, but in alternate embodiments, a client side-map database 109 may represent a compiled navigation database that may be used in or with end user devices (e.g., user equipment 101) to provide navigation and/or map-related functions. For example, the map database 109 may be used with the end user device 101 to provide an end user with navigation features. In such a case, the map database 109 can be downloaded or stored on the end user device (user equipment 101) which can access the map database 109 through a wireless or wired connection, over the network 105. This may be of particular benefit when used for navigating within spaces that may not have provisions for network connectivity or may have poor network connectivity, such as an indoor parking facility, a remote street near a residential area and the like. As many parking facilities are multi-level concrete and steel structures, network connectivity and global positioning satellite availability may be low or non-existent. In such cases, locally stored data of the map database 109 regarding the parking spaces may be beneficial as identification of suitable parking spot in the parking space could be performed without requiring connection to a network or a positioning system. In such an embodiment, various other positioning methods could be used to provide vehicle reference position within the parking facility, such as inertial measuring units, vehicle wheel sensors, compass, radio positioning means, etc.

In one embodiment, the end user device or user equipment 101 can be an in-vehicle navigation system, such as an ADAS, a personal navigation device (PND), a portable navigation device, a cellular telephone, a smart phone, a personal digital assistant (PDA), a watch, a camera, a computer, an infotainment system and/or other device that can perform navigation-related functions, such as digital routing and map display. An end user can use the user equipment 101 for navigation and map functions such as guidance and map display, for example, and for determination of one or more personalized routes or route segments, direction of travel of vehicle, heading of vehicles and the like. The direction of travel of the vehicle may be derived based on the heading value associated with a gantry on a link, such as a roadway segment.

In one example embodiment, the user equipment 101 may use the sensor data gathered by one or more sensors installed in the vehicle 103 to collect ground truth data for a plurality of ground truth points for the road signs. Such data for road signs may be collected by travelling through some of the selected links. The collected ground truth data may then be used in combination with several map based features and several sensor based features to identify an association of the ground truth data with the map based features and the sensors based features. The data related to the map based features and the sensor based features may be available such as in the map database 109 of the mapping platform. The association of the ground truth data with the map based features and the sensor based features may then be used to train a machine learning model. The training of the machine learning model may provide a trained machine learning model which may be configured to provide predictions about the location of a road sign based on the output of the trained machine learning model for any route along a navigation path.

Thus, using the system 100 disclosed herein provides an advantage that the vehicle 103 may not need to travel all the routes and/or links in a particular geographical region. Rather, using the supervised learning based machine learning model disclosed herein, may provide savings in a lot of time, effort, and cost which may otherwise be spent in collecting data about the road signs in all the links in a particular geographical region. Further, the machine learning model may be implemented by the processing component 111 of the mapping platform 107, and may also be used to detect locations of road objects, other than road signs, in some example embodiments. For the particular examples of road signs, there may be a plurality of types of road signs that may be detectable using the system 100 disclosed herein.

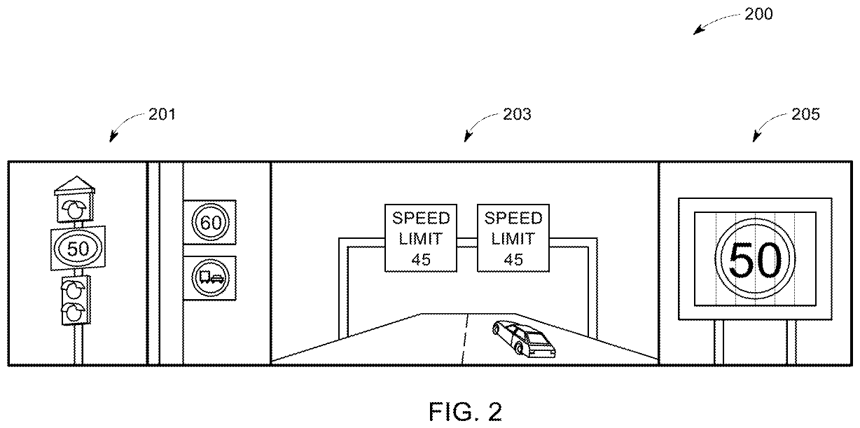

FIG. 2 illustrates a diagram showing a plurality of types of road signs 200 in accordance with an example embodiment. The plurality of types of road signs 200 may include a sign 201 placed near a traffic light, a gantry 203, or a sign board 205. The common characteristic amongst all these signs is that these are variable speed signs. The speed value displayed on these signs may change depending on time of day, traffic conditions, etc. Thus, in a navigation based system, such as the UE 101 installed in the vehicle 103, it is important to identify the correct speed values and provide accurate speed information for navigation related functions. Thus, the locations of these variable signs should be learned and updated timely to provide a good speed reference for autonomous and semi-autonomous vehicles. This needs road sign recognition systems which can correctly identify road signs and speed values displayed on them. The data for road signs may be maintained in a database of mapping application, such as the map database 109 of the mapping platform 107. The data stored in the map database 109 needs to be accurate and up-to-date for use in navigation applications. However, this may not always be the case in current road sign recognition systems.

Apart from the road signs 200 depicted in FIG. 2 which are variable speed signs or gantries, there may also be other types of road signs such as static signs that may be detected and predicted using the machine learning model disclosed in conjunction with the system 100 of FIG. 1. Such static speed signs may be stationary speed limit sign boards, placed along the sides of roads. In some cases, a vehicle' sensors may wrongly misclassify data related to a variable speed sign as data for a static speed sign and vice versa. Such sign misclassifications can be addressed using the methods and systems disclosed herein to correctly identify the type of road sign. Typically, data for a static speed sign, also referred to as a static speed sign observation, as gathered by a vehicle sensor may be of the format:

Static speed Sign observation

```
timeStampUTC_ms: 1519651499107
positionOffset {
  lateralOffset_m: 7.66664628952543945
  lateralOffsetSimple: LEFT
  longitudinalOffset_m: 4.232879151834717
  longitudinalOffsetSimple: FRONT
  verticalOffset_m: 2.85562801861084
  verticalOffsetSimple: AT_LEVEL
}
roadSignType: SPEED_LIMIT_START
roadSignPermanency: STATIC
roadSignValue: “80”
roadSignRecognitionType: SIGN_DETECTED
```

In some example embodiments, the static speed sign observation may be captured by a probe vehicle, such as the vehicle 103, and may be sent to the map database 109 for further processing.

In some example embodiments, the static speed sign observation may be captured by a vehicle equipped with an ADAS, such as the UE 101, and may be processed by the UE itself for providing navigation assistance related functions.

The data for a variable speed sign, also referred to as a variable speed sign observation, as gathered by a vehicle sensor may be of the format:

Variable speed sign observation

```
timeStampUTC_ms: 1519651504925
positionOffset {
  lateralOffset_m: 26.834823608398438
  lateralOffsetSimple: RIGHT
  longitudinalOffset_m: −5.0219268798828125
  longitudinalOffsetSimple: FRONT
  verticalOffset_m: 7.35687780380249
  verticalOffsetSimple: AT_LEVEL
}
roadSignType: SPEED_LIMIT_START
roadSignPermanency: VARIABLE
roadSignValue: “70”
roadSignRecognitionType: SIGN_DETECTED
```

Thus, the data for both the static speed sign observation and the variable speed sign observation may not be very different and may differ only in one parameter that is the “roadSignPermanency” flag, which may be “STATIC” for the static speed sign and “VARIABLE” for the variable speed sign. Thus, chances of misclassification among the two different road sign types may generally be very high. However, using the system 100, the misclassifications may be largely reduced by appropriately training the machine learning model using a combination of sensor based data with map based data, related to road sign observations. In some example embodiments, these road sign observations may be for a part of the road observations collected by the vehicles' sensors.

In some example embodiments, the variable speed sign observation may be captured by a probe vehicle, such as the vehicle 103, and may be sent to the map database 109 for further processing.

In some example embodiments, the variable speed sign observation may be captured by a vehicle equipped with an ADAS, such as the UE 101, and may be processed by the UE itself for providing navigation assistance related functions.

In some example embodiments, the road observations may be pre-processed before associating the road observations with the ground truth data about the road signs for training the machine learning model of system 100. For pre-processing the road observations, which may be plurality of vehicle sensor based observations for the road sign, vehicle sensor data for last n-days may be extracted, where ‘n’ may be a configurable number. Thus, the number of days for extracting the plurality of observations for the road sign may be predetermined as part of pre-processing of the road observation data.

Further, the vehicle sensor based sign observations may be map-matched to their correct road links. Map-matching may be done on the basis of a location and heading information of the observed sign, using road observation data, or of the vehicle when the vehicle observed the sign under. For the latter case, vehicles report an observed speed sign when the sign exits the field of view of the camera installed in the vehicle.

In some example embodiments, the road observation data may be collected on the basis of segmentation of link into multiple link segments. That is to say, instead of considering a link as a whole, the link may be broken down into link segments of equal length, with the exception of the last link segment. For example, each link segment may be of length 20m. The map-matched road observations may further be analyzed and filtered on the basis of link segmentation to form pre-processed road observations.

This may be done to reduce the processing load for processing the road observations and thereby increasing the efficiency of the overall system, such as the system 100 discussed in conjunction with FIG. 1.

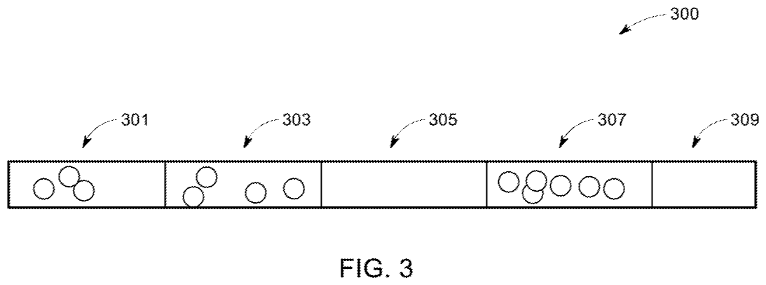

FIG. 3 illustrates an exemplary diagram illustrating segmentation of a link 300 for predicting location of a road sign according to an example embodiment.

The link 300 is divided into link segments 301-309, such that all the segments 301-307 before the last segment 309 are of equal lengths. The circles on the link segments 301, 303, and 307 represent the road observations which are observed on these link segments. Further, the lines between link segments are perpendicular bisectors which depict link segmentation. As can be noted from FIG. 3, for the link segments 305 and 309 there are no road observations. Thus, there is no need to process data related to link segments 305 and 309 and they can be omitted from a processing flow for road observations altogether, as per the methods and systems disclosed herein. Instead, the processing resources can only be focused on receiving and processing data for link segments 301, 303, and 307, saving a lot of computational cost. The reason is that it is very computer intensive to process all links in the map database 109 and only those with road observations are likely to contain a road sign, such as a gantry.

In some example embodiments, data about link segments may be stored in the map database 109, and road observation data collected by vehicle sensors may be associated with corresponding link segments for link segmentation.

Once the link segmentation has been performed and the corresponding map-matched road observations for each of the segmented links have been obtained, these observations may be used as the pre-processed road observations for further processing to predict the location of a road sign using the methods and systems disclosed herein. In some example embodiments, the pre-processed road observations may be used to extract one or more features for the map-matched road observations. The features may be used for training a machine learning model which may be used further in predicting the location of road signs, such as for new links where the probe vehicle may not even have travelled to collect data. Thus, using the machine learning model disclosed herein, the methods and systems of the present invention may be able to provide a supervised learning methodology for identifying various road objects and road signs, without having to spend huge computational and time intensive resources in collecting road sign observation data. The training of the machine learning model may be based on both sensor based features, as well map based features, to provide a more robust and accurate model which may be able to predict locations of road signs with high efficiency and accuracy. A feature may be a measurable characteristic associated with the sensor or the map, based on which type feature is being used. The feature may be used to provide domain data related to the sensor or the map. This domain data may be used along with ground truth data about presence or absence of road signs and gantries at various locations, which are also referred to as ground truth points, to form association patterns between features and ground truth points. These associations may be further used for various statistical analysis operations that may then be used for training the machine learning model for predicting the locations of various road signs.

The features may be of two types broadly: sensor based features and map based features.

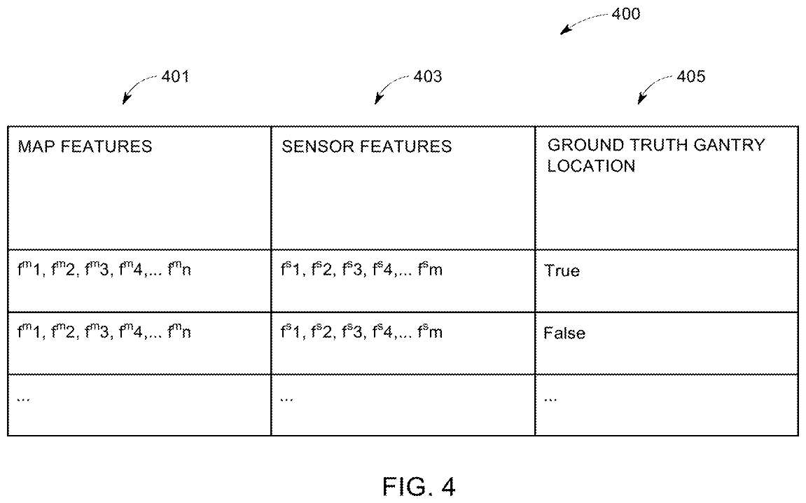

FIG. 4 illustrates an exemplary diagram illustrating association of a plurality of map based features and a plurality of sensor based features with ground truth data according to an example embodiment. This forms the training data set that will be fed to the machine learning model.

The table 400 of FIG. 4 illustrates a plurality of map based features, in column 401, and a plurality of sensor based features, in column 403, which may be used to form associations with a plurality of ground truth points, in column 405. The plurality of map based features 401 may be extracted from map data, such as data stored in the map database 109. The plurality of sensor based features may be extracted from sensor data, such as data collected by one or more sensors installed in the vehicle 103. In an example embodiment, the features may be extracted only for those link segments which have at least one road sign observation. For example, for the link 300 illustrated in FIG. 3, the features may be extracted only for link segments 301, 303 and 307.

In an example, the sensor based features may include one or more of:

Number of sign observations—an Integer data type;

Variable speed sign observation presence—a Boolean data type;

Static speed sign observation presence—a Boolean data type;

Number of different sign values present—an integer data type;

Fraction of total sign observations that is variable—a double data type; and

Fraction of total sign observation that is static—a double data type.

In some example embodiments, the data related to these plurality of sensor based features may be provided in an OEM database, which provides the OEM sensor for installation in the vehicle 103.

In addition to these sensor based features, a plurality of map based features may be extracted from a map database, such as the map database 109 of FIG. 1. The plurality of map based features may include one or more of:

Functional class;

Number of lanes;

Static speed limits;

Variable speed sign present;

Link length;

Rural/Urban flag;

Tunnel; and

Bridge

In an example embodiment, the plurality of map based features may also be extracted only for those link segments which have at least one road observation detected for it, for example for the link segments 301, 303 and 307 illustrated in FIG. 3.

Once the plurality of sensor based features and the plurality of map based features have been extracted from the plurality of pre-processed road observations discussed previously, the previously collected ground truth data may be used to identify associations between the sensor based features, the map based features and the ground truth data.

In an example embodiment, the ground truth data may be a collection of Boolean values for a plurality of ground truth locations which tells whether a road sign, or a gantry, is present at a location (ground truth point) or not.

For each row of a ground truth point 405, a set of map based features 401 from the plurality of map based features available for the plurality of pre-processed road observations are extracted. Similarly, for each row of a ground truth point 405, a set of sensor based features 403 from the plurality of sensor based features available for the plurality of pre-processed road observations may be extracted.

In the table 400, f^{m}i represents a map based feature, and f^{s}i represents a sensor based feature, where 0<i<∞.

The set of map based features 401 and the set of sensor based features 403 may then be associated with each row of the various ground truth points data 405 using distance and time measures. For example, we can associate sensor data with ground truth data if they are only a few centimeters apart.

In an example, such association analysis may be used to construct and train a machine learning model. The machine learning model may be constructed based on any of the machine learning classification algorithms known to a person of ordinary skill in the art. Such algorithms may include such as decision tree algorithm, random forest algorithm and the like.

In an example embodiment, the machine learning model may be constructed and trained on the basis of a regression algorithm, such as logistic regression.

In an example embodiment, the machine learning model may be trained based on a combination of a classification and a regression algorithm.

In an example, training the machine learning model may be used to detect how to identify the presence or absence of a road sign at a given location based on sensor and map based patterns.

In an example, such training may be performed in the cloud, such as using the processing component 111 of the cloud based mapping platform 107. The output of the trained machine learning may indicate whether a road sign or a gantry is present or absent at a location on a link segment.

Thus, using the association analysis and machine learning model construction discussed above, any link segment on any given link or road may be selected. A set of map based features and a set of sensor based features may be extracted for that link segment. These features may then be passed to the trained machine learning model, and the trained machine learning model may then output “TRUE” or “FALSE” based on whether a road sign is present or absent respectively on that link segment. Thus, using the trained machine learning model, a link segment with output of the model=TRUE is considered to have a road sign. The location of the road sign may then be identified as a statistical measure, such as average, of all the location values for all the road observations for that link segment.

Thus, using the statistical and analytical techniques described herein, a supervised machine learning model may be generated for identifying the location of a road sign.

In some example embodiments, the supervised machine learning model may be used to identify the location of a road object apart from a road sign. For example, such road objects may be tunnels, diversions, turns, intersections, accident sites, danger prone areas, sharp turns, bends, elevations and the like.

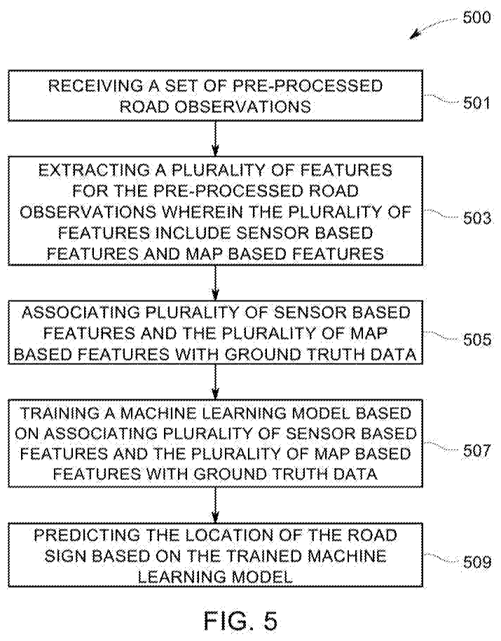

FIG. 5 illustrates a flow diagram of a method 500 for identifying a location of a road sign according to an example embodiment. The method 500 may be based on the machine learning model discussed in conjunction with FIG. 4.

The method 500 may include, at 501, receiving a set of pre-processed road observations. The pre-processing may include such as performing road observation data extraction for a plurality of road observations for a predetermined number of days, map-matching the road observations with a plurality of links and performing link segmentation as discussed previously. Further, once the pre-processed road observations have been received, the method 500 may include, at 503, extracting a plurality of features for the pre-processed road observations, wherein the plurality of features include sensor based features and map based features. The sensor based features may include such as number of sign observations, a variable speed sign observation presence indicator, a static speed sign observation presence indicator, number of different sign values present, a fraction value of total sign observations that is variable, and a fraction value of total sign observation that is static.

The map based features may include such as a functional class, number of lanes, a static speed limit value, a variable speed sign present status indicator, a link length, a rural or urban flag indicator, a tunnel, and a bridge. Once the features have been extracted, the method 500 may include, at 505, associating a set of sensor based features and a set of map based features, from the previously extracted features, with ground truth data. The ground truth data is a Boolean value indicating presence or absence of a road sign, such as a gantry, at various locations. Each location corresponds to a ground truth point. The association of the feature data with ground truth data may be used in the method 500, at 507, for training a machine learning model.

In an example embodiment, the machine learning model may be trained using a classification algorithm.

In an example embodiment, the machine learning model may be trained using a regression algorithm.

After training phase, the trained machine learning model may be used at 509, for predicting the location of the road sign based on the training. The procedure to use the already trained model is just to supply the sensor and map based features and the model will output whether or not the given segment contains the road sign. If a segment is predicted to contain a road sign, then the location can be inference from road observations within that segment. For example, location of the prediction could be the mean location of all the road observations on the segment.

In an example embodiment, an apparatus for performing the method 500 of FIG. 5 above may comprise a processor (e.g. the processor 111) configured to perform some or each of the operations of the method of FIG. 5 described previously. The processor may, for example, be configured to perform the operations (501-509) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (501-509) may comprise, for example, the processor 111 which may be implemented in the user equipment 101 and/or a device or circuit for executing instructions or executing an algorithm for processing information as described above.

In an example embodiment, the method 500 may enable saving a lot of time and cost which may be spent in traditional approaches for detecting road signs and gantries using probe vehicles.

On the contrary, using the method 500, only a small amount of road signs, road objects, gantries and the like may be detected. Using those detected road signs, road objects or gantries as ground truth, the machine learning model may be trained to automatically recognize such road objects, road signs or gantries, along with sensor based and map based features or patterns.

In an example embodiment, the method 500 may be used for detecting road objects other than road signs. Such detection may be used to provide risk-free driving assistance to a driver in a vehicle, thereby reducing the overall driving burden on the driver, and at the same time, providing a time and cost-efficient solution for navigation assistance and cloud based database update.

Many modifications and other embodiments of the invention set forth herein will come to mind to one skilled in the art to which these inventions pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for predicting a location of a road sign, comprising:
receiving a set of pre-processed road observations;
extracting a plurality of features from the set of pre-processed road observations, wherein the plurality of features comprise at least a plurality of sensor based features and a plurality of map based features;
associating a set of sensor based features from the plurality of sensor based features and a set of map based features from the plurality of map based features with at least one of a plurality of ground truth points in ground truth data;
training a machine learning model based on the association of the ground truth data with the set of sensor based features and the set of map based features with at least one of a plurality of ground truth points in the ground truth data; and
predicting the location of the road sign based on the trained machine learning model.

2. The method of claim 1 wherein the ground truth data is collected by probe vehicles for a plurality of ground truth locations, wherein the ground truth data is a Boolean value indicating a presence or absence of the road sign for at least one of the plurality of ground truth locations.

3. The method of claim 1 wherein receiving the set of pre-processed road observations further comprises:
extracting a plurality of vehicle sensor based observations from the set of pre-processed road observations for a predetermined number of days;
map-matching each of the plurality of vehicle sensor based observations to a plurality of links;
segmenting at least one of the plurality of links into link segments;
selecting at least one of the link segments containing at least one map-matched vehicle sensor based observation; and
providing the at least one map-matched vehicle sensor based observation as at least one of the set of pre-processed road observations.

4. The method of claim 1, wherein the plurality of map based features are selected from a group comprising at least a functional class, number of lanes, a static speed limit value, a variable speed sign present status indicator, a link length, a rural or urban flag indicator, a tunnel, and a bridge.

5. The method of claim 1, wherein the plurality of sensor based features are selected from a group comprising at least number of sign observations, a variable speed sign observation presence indicator, a static speed sign observation presence indicator, number of different sign values present, a fraction value of total sign observations that is variable, and a fraction value of total sign observation that is static.

6. The method of claim 1, wherein the machine learning model is trained based on a machine algorithm selected from a group comprising at least one of a decision tree algorithm, a random forest algorithm, and a regression algorithm.

7. The method of claim 1, further comprising:
predicting presence of the road sign at the location if an output of the machine learning model is true; and
predicting absence of the road sign at the location if the output of the machine learning model is false.

8. The method of claim 7, further comprising:
identifying a statistical measure of all the pre-processed road observations if the output of the machine learning model is true.

9. The method of claim 8, wherein the statistical measure is the mean location of all the pre-processed road observations.

10. An apparatus for predicting a location of a road sign, the apparatus comprising:
at least one processor; and
at least one memory including computer program code for one or more programs,
the at least one memory and the computer program code configured to, with the at least one processor, cause the apparatus to perform at least the following:
receive a set of pre-processed road observations;
extract a plurality of features from the set of pre-processed road observations, wherein the plurality of features comprise at least a plurality of sensor based features and a plurality of map based features;
associate a set of sensor based features from the plurality of sensor based features and a set of map based features from the plurality of map based features with at least one of a plurality of ground truth points in ground truth data;
train a machine learning model based on the association of the ground truth data with the set of sensor based features and the set of map based features with at least one of a plurality of ground truth points in the ground truth data; and
predict the location of the road sign based on the trained machine learning model.

11. The apparatus of claim 10 wherein the ground truth data is collected by probe vehicles for a plurality of ground truth locations, wherein the ground truth data is a Boolean value indicating a presence or absence of the road sign for at least one of the plurality of ground truth locations.

12. The apparatus of claim 10 wherein to receive the set of pre-processed road observations, the apparatus is further caused to perform at least the following:
extract a plurality of vehicle sensor based observations from the set of pre-processed road observations for a predetermined number of days;
map-match each of the plurality of vehicle sensor based observations to a plurality of links;
segment at least one of the plurality of links into link segments;
select at least one of the link segments containing at least one map-matched vehicle sensor based observation; and
provide the at least one map-matched vehicle sensor based observation as at least one of the set of pre-processed road observations.

13. The apparatus of claim 10, wherein the plurality of map based features are selected from a group comprising at least a functional class, number of lanes, a static speed limit value, a variable speed sign present status indicator, a link length, a rural or urban flag indicator, a tunnel and a bridge.

14. The apparatus of claim 10, wherein the plurality of sensor based features are selected from a group comprising at least number of sign observations, a variable speed sign observation presence indicator, a static speed sign observation presence indicator, number of different sign values present, a fraction value of total sign observations that is variable and a fraction value of total sign observation that is static.

15. The apparatus of claim 10, wherein the machine learning model is trained based on a machine algorithm selected from a group comprising at least one of a decision tree algorithm, a random forest algorithm and a regression algorithm.

16. A computer program product comprising at least one non-transitory computer-readable storage medium having computer-executable program code instructions stored therein, the computer-executable program code instructions comprising program code instructions for:
receiving a set of pre-processed road observations;
extracting a plurality of features from the set of pre-processed road observations, wherein the plurality of features comprise at least a plurality of sensor based features and a plurality of map based features;
associating a set of sensor based features from the plurality of sensor based features and a set of map based features from the plurality of map based features with at least one of a plurality of ground truth points in ground truth data;
training a machine learning model based on the association of the ground truth data with the set of sensor based features and the set of map based features with at least one of a plurality of ground truth points in the ground truth data; and
predicting the location of the road sign based on the trained machine learning model.

17. The computer program product of claim 16, wherein the ground truth data is collected by probe vehicles for a plurality of ground truth locations, wherein the ground truth data is a Boolean value indicating a presence or absence of the road sign for at least one of the plurality of ground truth locations.

18. The computer program product of claim 16 wherein receiving the set of pre-processed road observations further comprises program code instructions for:
extracting a plurality of vehicle sensor based observations from the set of pre-processed road observations for a predetermined number of days;
map-matching each of the plurality of vehicle sensor based observations to a plurality of links;
segmenting at least one of the plurality of links into link segments;
selecting at least one of the link segments containing at least one map-matched vehicle sensor based observation; and
providing the at least one map-matched vehicle sensor based observation as at least one of the set of pre-processed road observations.

19. The computer program product of claim 16, wherein the plurality of map based features are selected from a group comprising at least a functional class, number of lanes, a static speed limit value, a variable speed sign present status indicator, a link length, a rural or urban flag indicator, a tunnel and a bridge.

20. The computer program product of claim 16, wherein the plurality of sensor based features are selected from a group comprising at least number of sign observations, a variable speed sign observation presence indicator, a static speed sign observation presence indicator, number of different sign values present, a fraction value of total sign observations that is variable and a fraction value of total sign observation that is static.
